(19) United States
(12) Patent Application Publication
(10) Pub. No.: US 2010/0159821 A1
(43) Pub. Date: Jun. 24, 2010

(54) EXHAUST WALL CAP VENT SLEEVE UNIT

(75) Inventors: Thomas Bredahl, Miami Springs, FL (US); John Leete, Fort Lauderdale, FL (US)

Correspondence Address: SUGHRUE MION, PLLC, 2100 PENNSYLVANIA AVENUE, N.W., SUITE 800, WASHINGTON, DC, 20037, US

(73) Assignee: FSH INDUSTRIES, LLC, Miami Springs, FL (US)

(21) Appl. No.: 12/646,804

(22) Filed: Dec. 23, 2009

Related U.S. Application Data
(60) Provisional application No. 61/140,509, filed on Dec. 23, 2008.

(51) Int. Cl. F24F 13/08; B23P 19/04

(52) U.S. Cl. 454/358; 29/700

(57) ABSTRACT

An exhaust vent apparatus provides a wall vent sleeve including a rear opening and a front opening, and a moveable damper disposed within the wall vent sleeve at a recessed position from the front opening, wherein the moveable damper conducts gas flow in a direction from the rear opening to the front opening and prevents gas flow in a direction from the front opening and to the rear opening.

### CROSS-REFERENCE TO RELATED APPLICATIONS

This application claims priority from U.S. Provisional Application No. 61/140,509, filed Dec. 23, 2008 in the U.S. Patent and Trademark Office, the disclosure of which is incorporated herein by reference.

### BACKGROUND OF THE INVENTION

1. Field of the Invention

Apparatuses and methods consistent with the present invention relate to exhaust systems for buildings, and more particularly to a wall cap vent sleeve unit for conducting exhaust gasses from an exhaust duct through a wall of a building and a method of installing a wall cap vent sleeve unit in a wall.

2. Related Art

Many existing buildings have exhaust wall caps that fail to provide proper protection with regards to water and air intrusion. With the existing wall cap, a spring loaded backdraft damper is installed on a plane parallel with the exterior of the building and is shrouded by a plastic or aluminum hood, thus providing limited performance of the spring loaded backdraft damper. As air flows up the building, the damper is easily opened and subsequently fails to prevent air and/or water and/or moisture from entering the interior of the building through the wall cap. In addition, the damper spring is eventually stretched past its elastic limit and fails to provide the necessary closing force on the damper, thereby exacerbating the problem.

### SUMMARY OF THE EXEMPLARY EMBODIMENTS

Exemplary embodiments of the present invention overcome the disadvantages described above and other disadvantages not described above. Also, the present invention is not required to overcome the disadvantages described above, and an exemplary embodiment may not overcome any of the problems described above.

The present exemplary embodiments provide an exhaust wall cap vent sleeve unit with a recessed damper assembly incorporated into a wall cap sleeve for conducting exhaust gasses from an exhaust duct through a wall of a structure and a method for installing the same which slides into an exhaust duct.

An aspect of the present exemplary embodiments provides an exhaust vent apparatus having a wall vent sleeve with a rear opening and a front opening; and a moveable damper disposed within the wall vent sleeve at a recessed position from the front opening. The moveable damper conducts gas flow in a direction from the rear opening to the front opening and prevents gas flow in a direction from the front opening and to the rear opening.

Another aspect of the present exemplary embodiments provides a vent system having

a wall vent sleeve which conducts gasses to be vented; a moveable damper disposed at a recessed position within the wall vent sleeve and which allows gas flow in a first direction and prevents gas flow in an opposite direction; a sleeve seal which seals between the wall vent sleeve and an inner circumferential surface of a duct disposed on an outer circumference of the wall vent sleeve; a louver frame which is not attached to the wall vent sleeve; and a louver assembly which is removeably attached to the louver frame and is disposed over the front opening of the wall vent sleeve.

Yet another aspect of the present exemplary embodiments provides a method of installing an exhaust vent apparatus, the method including the steps of inserting a wall cap sleeve with a sleeve seal into an exhaust duct; affixing a vent sleeve flange to an exterior surface of a structure; affixing a louver frame to the exterior of the structure; and attaching a louver assembly to the louver frame.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is an exploded view of an exhaust wall cap vent sleeve unit according to a non-limiting exemplary embodiment;

FIG. 2 is a rear perspective view of the exhaust wall cap vent sleeve unit according to a non-limiting exemplary embodiment;

FIG. 3A is a perspective view of a sleeve seal according to a non-limiting exemplary embodiment;

FIG. 3B is a cross sectional view of the sleeve seal according to a non-limiting exemplary embodiment;

FIG. 4 is a front perspective view of a backdraft damper according a non-limiting exemplary embodiment;

FIG. 5 is an illustration showing the center of gravity of the backdraft damper according a non-limiting exemplary embodiment;

FIG. 6 is a front view of a louver frame according to a non-limiting exemplary embodiment;

FIG. 7 is a front view of a louver assembly according to a non-limiting exemplary embodiment; and

FIG. 8 is a flowchart illustrating a method of installing the exhaust wall cap vent sleeve unit according to a non-limiting exemplary embodiment.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

Exemplary embodiments provide an exhaust wall cap vent sleeve unit with a recessed damper assembly incorporated into a wall cap sleeve which installs into an existing exhaust duct. The exemplary embodiments of the exhaust wall cap vent sleeve unit may be constructed from non-corrosive and/or high-impact materials.

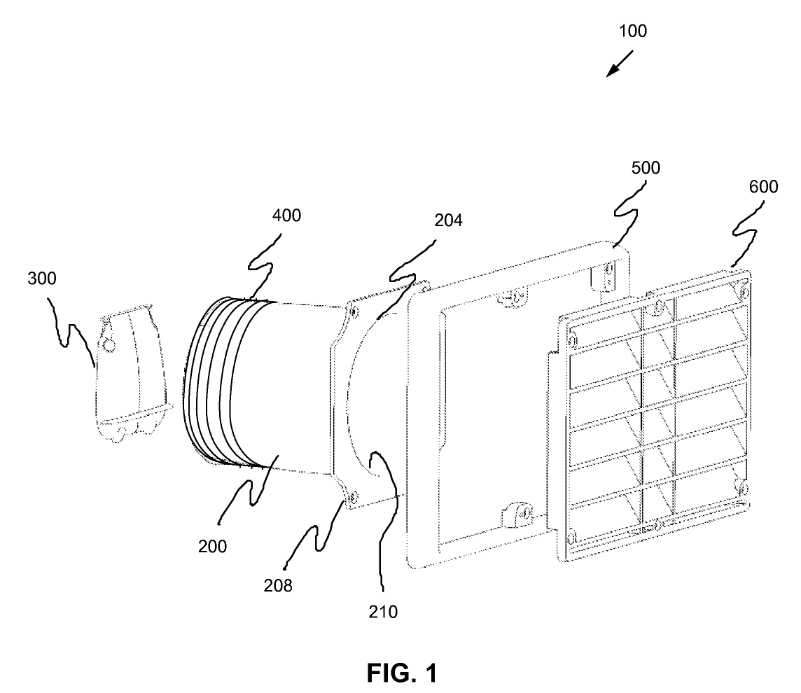

FIG. 1 is an exploded view of an exhaust wall cap vent sleeve unit according to a non-limiting exemplary embodiment. Referring to FIG. 1, the exhaust wall cap vent sleeve unit 100 includes a damper assembly 102 which has a recessed gravity operated backdraft damper 300 incorporated into a wall cap sleeve 200 which retains the backdraft damper 300. A sleeve seal 400 is disposed around the circumference of the wall cap sleeve 200. The wall cap sleeve 200 and sleeve seal 400 slide into an existing exhaust duct of a building. A flange 208 may be attached to a surface of the building to secure the wall cap sleeve 200. The flange 208 may be secured to the building surface with, for example, but not limited to, screws or nails. Alternatively or additionally, adhesive, caulking, or other gasket material may be used to secure and seal the flange 208 to the surface of the building. A louver frame 500 is positioned at a front opening 204 of the wall cap sleeve 200. A louver assembly 600 attaches to the louver frame 500, thereby covering the front opening 204 of the wall cap sleeve 200.

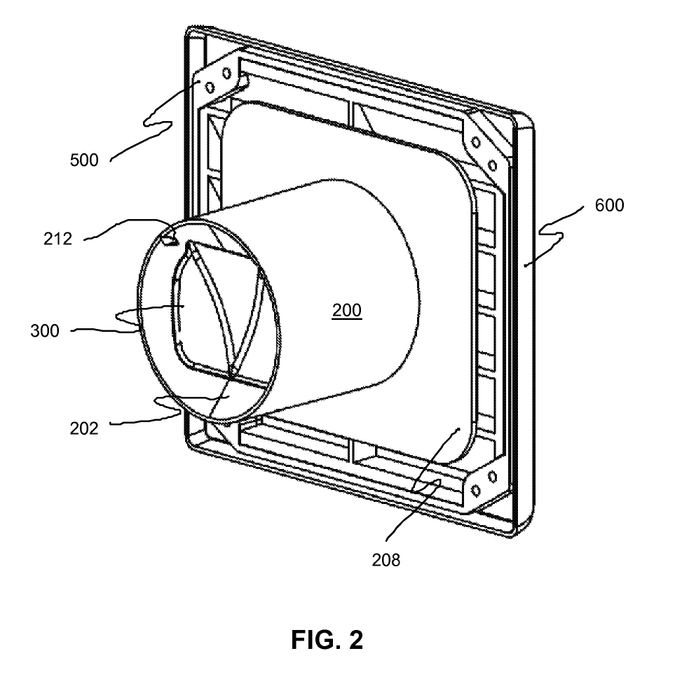

FIG. 2 is a rear perspective view of the exhaust wall cap vent sleeve unit according to a non-limiting exemplary embodiment. Referring to FIG. 2, the backdraft damper 300 is disposed at a recessed position within the wall cap sleeve 200. A rear opening 202 of the wall cap sleeve 200 is contoured to slope inward from the interior wall of the wall cap sleeve 200 toward the opening for the backdraft damper 300. The contour of the rear opening 202 acts to divert air flow into the sleeve opening thus minimizing static pressure. The rear opening 202 provides a large opening while maintaining an allowable backdraft damper 300 opening angle. Referring again to FIG. 1, a bottom portion 210 of the interior surface of the wall cap sleeve 200 is pitched downward toward the front opening 204 to minimize accumulation of moisture.

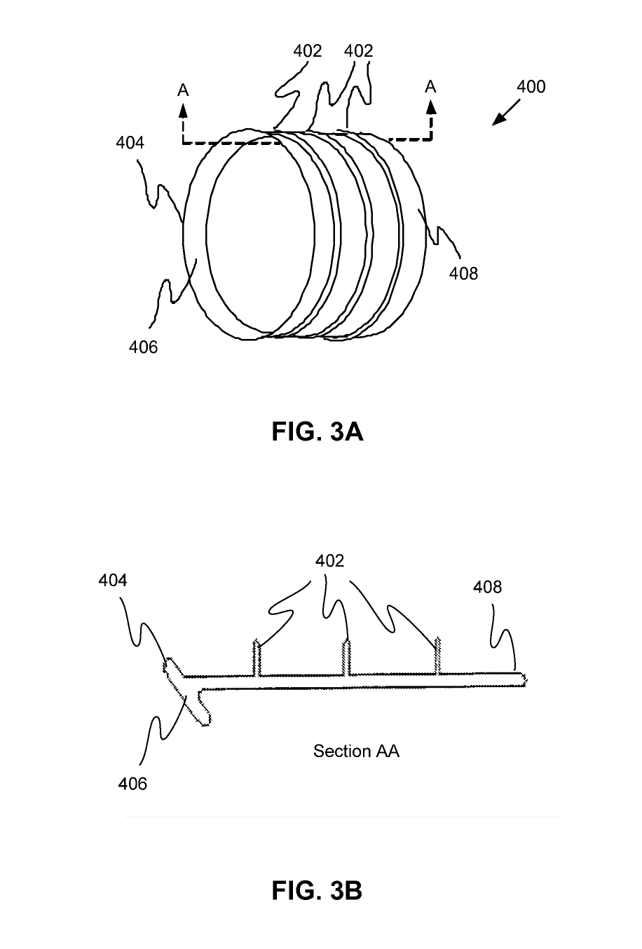

FIG. 3A is a perspective view of a sleeve seal and FIG. 3B is a cross sectional view of the sleeve seal according to a non-limiting exemplary embodiment. The sleeve seal 400 is of substantially cylindrical shape having an inner circumference appropriate to allow the sleeve seal 400 to be disposed around the outer circumference of the wall cap sleeve 200 to prevent intrusion of water between the wall cap sleeve 200 and the building exhaust duct. The sleeve seal may be manufactured from resilient material, for example, but not limited to, elastomeric rubber. As illustrated in FIGS. 3A and 3B, three circumferential fins 402 disposed along the length of the body 408 of the sleeve seal 400 provide a substantially air tight seal between the wall cap sleeve 200 and the exhaust duct. One of ordinary skill in the art will appreciate that the number of circumferential fins may be more or less than three. The rear edge 404 of the sleeve seal 400 continues the contoured profile of the rear opening 202 of the wall cap sleeve 200 to provide a transition from the inner circumferential surface of the duct to the rear opening 202 of the wall cap sleeve 200 thereby minimizing edges that may catch lint or increase static pressure. As further illustrated in FIG. 3B, the rear edge 404 of the sleeve seal 400 provides a contour portion 406 which forms a seal between the inner circumferential surface of the duct and the wall cap sleeve 200. The contour portion 406 forms a smooth transition between the duct and rear opening 202 contour of the wall cap sleeve 200 to minimizing static pressure and particulate buildup.

While the exemplary embodiment illustrates a sleeve seal disposed at a rear portion of the wall cap sleeve, one of skill in the art will recognize that other configurations of the sleeve seal are possible without departing from the scope of the present inventive concept.

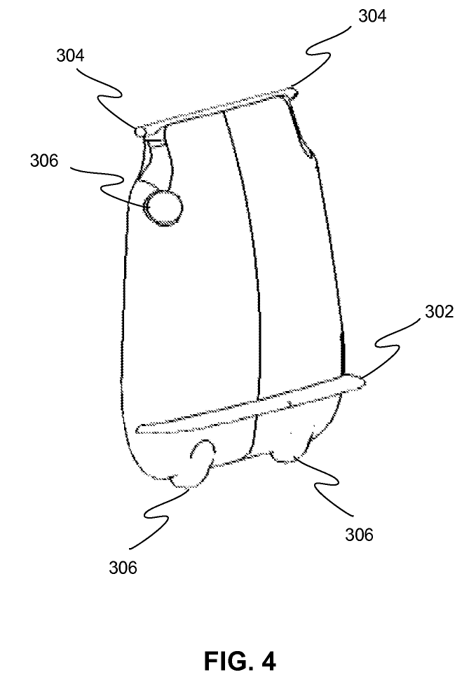

FIG. 4 is a front perspective view of a backdraft damper according an exemplary embodiment. Referring to FIG. 4, the backdraft damper 300 has a concave shape which maximizes the opening area for air flow. In addition, the backdraft damper 300 is contoured to the inside shape of the wall cap sleeve 200 to provide a wide opening.

The backdraft damper 300 includes a horizontal leading edge airflow spoiler 302 disposed at a lower portion of a front surface of the backdraft damper 300. The airflow spoiler 302 provides a downward force on the backdraft damper 300 under windy conditions, thus preventing the backdraft damper 300 from opening and closing (flutter) as a result of wind.

The backdraft damper 300 is provided with axial protrusions 304 disposed at a top portion of the backdraft damper 300 which engage corresponding receiving portions 212 disposed on the inner wall of the wall cap sleeve 200 (see FIG. 2) providing a hinge structure to pivotably mount the backdraft damper 300 and allow the backdraft damper 300 to open to accommodate exhaust flow and close to prevent entry of wind and water. The axial protrusions 304 in combination with the receiving portions 212 of the wall cap sleeve 200 allow removal of the backdraft damper 300 from the wall cap sleeve 200. More particularly, one of the receiving portions 212 of the wall cap sleeve 200 includes a horizontal slot which allows the backdraft damper 300, when moved to an open position, to be urged towards the receiving portions 212 having the horizontal slot, thereby releasing the backdraft damper 300 from the wall cap sleeve 200.

The backdraft damper 300 is disposed within the wall cap sleeve 200 at a position nearer to the rear opening 202 of the wall cap sleeve 200 than to the front opening thereby being located within the wall cap sleeve 200 at a recessed position from the front opening 204. The backdraft damper 300 may be disposed within the wall cap sleeve 200 at a position adjacent the rear opening 202 of the wall cap sleeve 200 such that when open to a substantially horizontal position, the backdraft damper 300 is still entirely within the interior of the wall cap sleeve 200.

The backdraft damper 300 is moveable to provide for flow of exhaust gas in a direction from the rear opening 202 of the wall cap sleeve 200 to the front opening 204 and prevent flow of air and moisture in a direction from the front opening 204 of the wall cap vent sleeve 200 to the rear opening 202.

Additionally, one or more bumpers 306 may be positioned on the backdraft damper 300 dampen the sound of the backdraft damper 300 closing. The bumpers 306 may be constructed from, for example, but not limited to, ethylene propylene diene Monomer (EPDM) rubber.

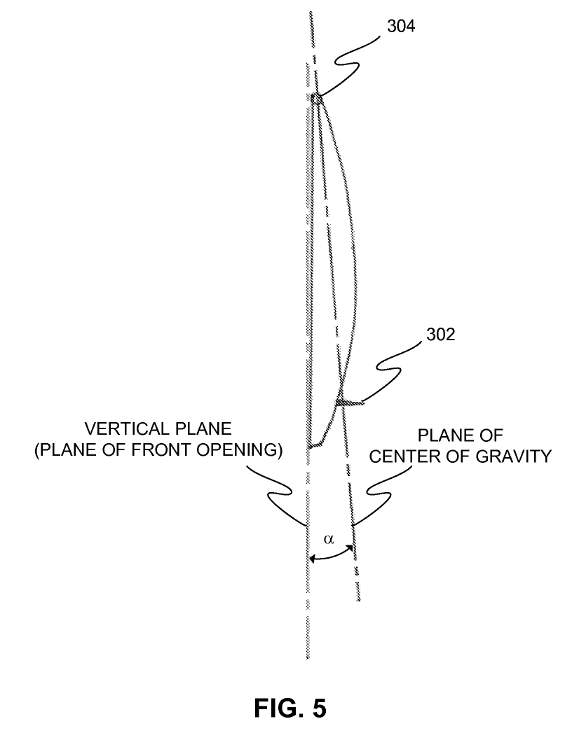

FIG. 5 is an illustration showing the center of gravity of the backdraft damper according an exemplary embodiment. The plane of the center of gravity of the backdraft damper 300 passing through the axial protrusions 304 is offset from a vertical plane by angle α in a range of 2-5 degrees. The vertical plane coincides approximately with the plane of the front opening 204 of the wall cap sleeve 200 thereby providing gravity operated closing of the backdraft damper 300. The offset center of gravity plane produces a forced closed position of the backdraft damper 300.

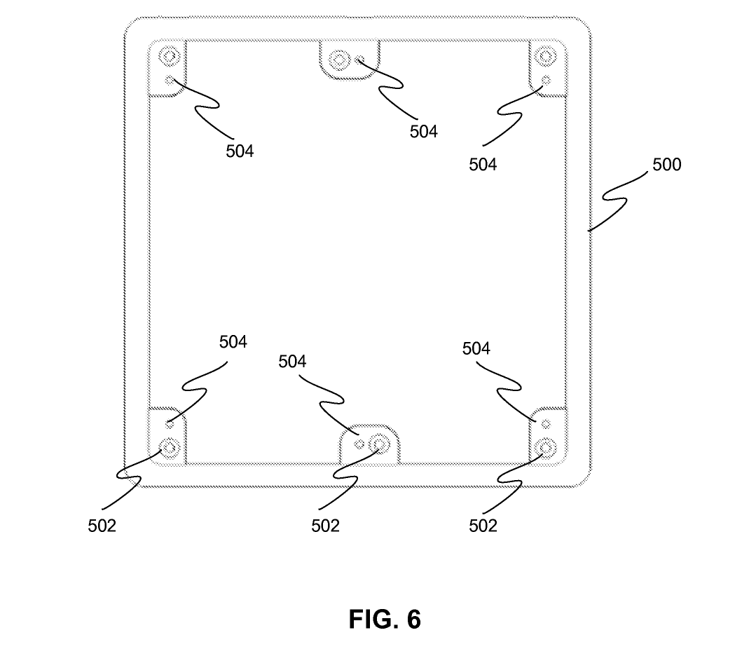

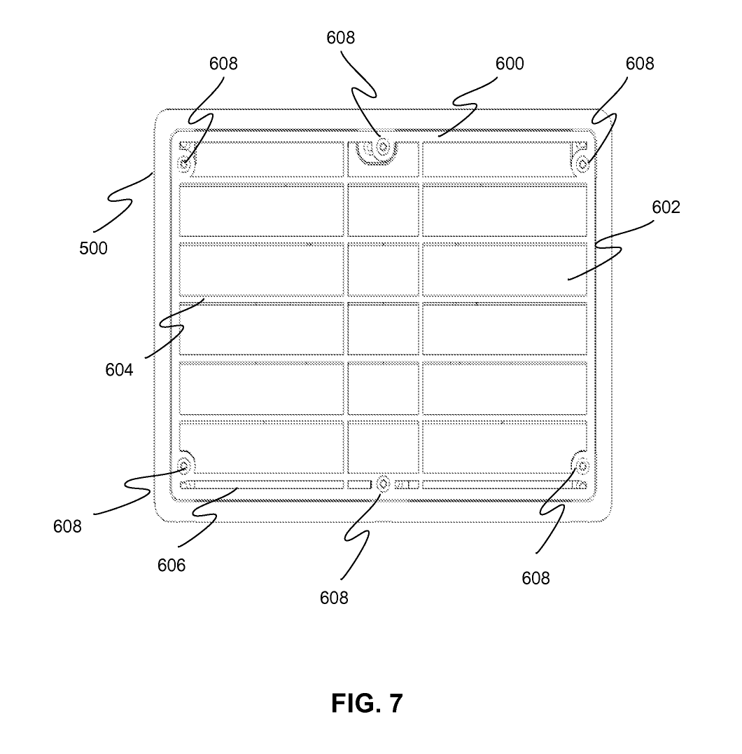

FIG. 6 is a front view of a louver frame according to a non-limiting exemplary embodiment and FIG. 7 is a front view of a louver assembly according to a non-limiting exemplary embodiment. The louver frame 500 is positioned at a front opening 204 of the wall cap sleeve 200 and is separate from the wall cap sleeve 200. The louver frame 500 is affixed to the exterior surface of a building. A first plurality of mounting holes 502 may be provided for this purpose. The louver frame may be attached to the exterior surface of the building using, for example, but not limited to, screws or nails. Additionally, the louver frame 500 and louver assembly 600 can be mounted on any exterior surface such as stucco, siding, brick, etc.

A second plurality of holes 504 may be provided to attach the louver assembly 600 to the louver frame 500. The louver assembly 600 attaches to the louver frame 500, thereby covering the front opening 204 of the wall cap sleeve 200. A plurality of mounting holes 608 may be provided for this purpose. The louver assembly 600 is also separate from the wall cap sleeve 200. Separate mounting of the louver frame 500 and louver assembly 600 from the wall cap sleeve 200 allows for correction of vertical and horizontal alignment variations in duct outlet location from floor-to-floor on the exterior of a building. In addition, the louver frame 500 and louver assembly 600 combination has a low exterior profile of approximately 0.75 inches which provides an aesthetically pleasing flush appearance on the building exterior.

The louver assembly 600 is removably attached to the louver frame 500 with, for example, but not limited to, screws or other removable fasteners, and may be removed for periodic inspections and or maintenance of the wall cap sleeve 200 and backdraft damper 300. This removable louver assembly 600 configuration advantageously provides for removal of the louver assembly 600 to perform maintenance of the exhaust wall cap vent sleeve unit 100 without compromising the sealing integrity between the wall cap sleeve 200 and the structure.

The louver assembly 600 also aids the performance of the backdraft damper 300. Louvers 602 of the louver assembly 600 are angled at approximately 30 degrees from horizontal with the exterior edges 604 of the louvers 602 lower than their internal edges. The angle of the louvers 602 redirects the air upward as it passes through the louvers 602 and urges the backdraft damper 300 to a closed position by applying a downward force on the airflow spoiler 302.

In addition, the louver assembly 600 may also include drainage holes 606 disposed at a lower portion of the louver assembly 600 which operate in conjunction with the bottom portion 210 of the wall cap sleeve 200 which is pitched toward the front opening 204 of the to provide for drainage of moisture which enters the wall cap sleeve 200. Also, the louver frame 500 and louver assembly 600 may be color matched to the exterior of the building.

While one non-limiting exemplary embodiment of the louver assembly 600 is illustrated in FIG. 7, one of ordinary skill in the art will also understand that other louver assembly configurations which minimize entry of external elements and allow exhaust gas flow to the ambient environment are possible.

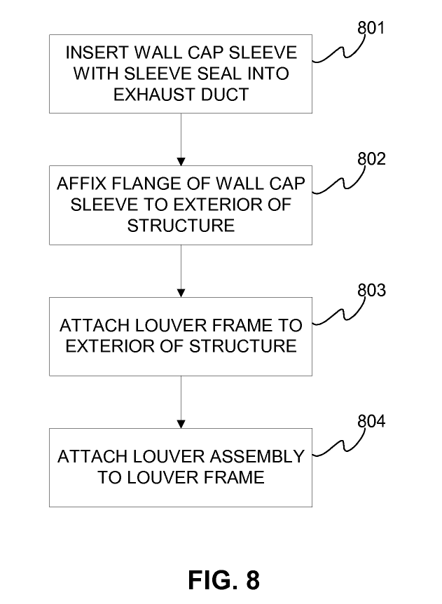

FIG. 8 is a flowchart illustrating a method of installing the exhaust wall cap vent sleeve unit 100 according to a non-limiting exemplary embodiment. Referring to FIG. 8, a method of installing the exhaust wall cap vent sleeve unit 100 may be performed as follows. A wall cap sleeve 200 with a sleeve seal 400 is inserted into an exhaust duct in a structure (S810) and a vent sleeve flange 208 is affixed to the exterior of the structure (S820). After the wall cap sleeve 200 and sleeve seal 400 are installed, a louver frame 500 is aligned as necessary and affixed to the exterior of the structure (S830). After the louver frame 500 is attached, a louver assembly 600 is attached to the louver frame 500 (S840).

An exhaust wall cap vent sleeve unit for conducting exhaust gasses from an exhaust duct through a wall of a structure and a method for installing the same have been provided. While the invention has been particularly shown and described with reference to a few exemplary embodiments, it will be understood and appreciated by those skilled in the art that various changes in form and details may be made therein without departing from the principles and spirit of the invention, the scope of which is defined in the appended claims and their equivalents.

What is claimed is:

1. An exhaust vent apparatus comprising:
a wall vent sleeve comprising a rear opening and a front opening; and
a moveable damper disposed within the wall vent sleeve at a recessed position from the front opening,
wherein the moveable damper conducts gas flow in a direction from the rear opening to the front opening and prevents gas flow in a direction from the front opening and to the rear opening.

2. The apparatus according to claim 1, wherein the rear opening is contoured to slope inward from an interior wall of the wall cap sleeve toward an opening for the moveable damper.

3. The apparatus according to claim 2, further comprising a sleeve seal disposed around a portion of an outer circumference of the wall vent sleeve.

4. The apparatus according to claim 3, wherein the sleeve seal comprises:
a cylindrical body having an inner circumference dimensioned to fit an outer circumference of the wall vent sleeve;
a plurality of circumferential fins disposed along the length of the body; and
a rear edge contoured to provide a substantially smooth transition from an inner circumferential surface of a duct to an inner circumferential surface of the rear opening of the wall vent sleeve.

5. The apparatus according to claim 3, wherein the rear edge of the sleeve seal continues the contoured profile of the rear opening of the wall cap sleeve.

6. The apparatus according to claim 1, wherein the moveable damper comprises a horizontal airflow spoiler disposed at a lower portion of a front surface of the damper.

7. The apparatus according to claim 6, wherein the moveable damper further comprises axial protrusions disposed at a top portion of the damper which engage corresponding receiving portions disposed on an inner wall of the wall cap sleeve.

8. The apparatus according to claim 7, wherein a plane of the center of gravity of the damper passing through the axial protrusions is offset from a vertical plane.

9. The apparatus according to claim 8, wherein an angle formed between the plane of the center of gravity of the damper and the vertical plane is in a range of 2-5 degrees.

10. The apparatus according to claim 1, further comprising:
a louver frame disposed at the front opening of the wall vent sleeve which is not attached to the wall vent sleeve; and
a louver assembly which is removeably attached to the louver frame and is disposed over the front opening of the wall vent sleeve.

11. The apparatus according to claim 10, wherein the louver assembly comprises:
a plurality of louvers; and
a plurality of drainage holes disposed at a lower portion of the louver assembly.

12. The apparatus according to claim 11, wherein the plurality of louvers are angled at approximately 30 degrees from horizontal with the exterior edges of the louvers lower than their internal edges.

13. The apparatus according to claim 1, wherein a bottom portion of an interior surface of the wall cap sleeve is pitched downward toward the front opening.

14. A vent system comprising:
a wall vent sleeve which conducts gasses to be vented;
a moveable damper disposed at a recessed position within the wall vent sleeve and which allows gas flow in a first direction and prevents gas flow in an opposite direction;
a sleeve seal which seals between the wall vent sleeve and an inner circumferential surface of a duct disposed on an outer circumference of the wall vent sleeve;
a louver frame which is not attached to the wall vent sleeve; and
a louver assembly which is removeably attached to the louver frame and is disposed over the front opening of the wall vent sleeve.

15. The vent system of claim 14, wherein the sleeve seal comprises a plurality of circumferential fins disposed along the length of a cylindrical body.

16. The vent system of claim 14, wherein the moveable damper is pivotably mounted by axial protrusions disposed at a top portion of the damper which engage corresponding receiving portions disposed on an inner wall of the wall cap sleeve.

17. The vent system of claim 16, wherein a plane of the center of gravity of the damper passing through the axial protrusions is offset from a vertical plane substantially parallel to a front opening of the wall cap sleeve.

18. The vent system of claim 16, wherein the moveable damper comprises a horizontal airflow spoiler disposed at a lower portion of a front surface of the damper.

19. The vent system of claim 16, wherein the moveable damper has a concave shape.

20. A method of installing an exhaust vent apparatus, the method comprising:
inserting a wall cap sleeve with a sleeve seal into an exhaust duct;
affixing a vent sleeve flange to an exterior surface of a structure;
affixing a louver frame to the exterior of the structure; and
attaching a louver assembly to the louver frame.
